(19) United States
(12) Patent Application Publication
(10) Pub. No.: US 2026/0321153 A1
(43) Pub. Date: Oct. 15, 2026

(54) SYSTEM AND METHOD FOR MACHINE LEARNING ASSISTED GENERATION OF PERSONALIZED LEARNING CONTENT AND FOR MANAGEMENT OF CONTENT CONSUMPTION

(71) Applicants: Constructor Technology AG, Schaffhausen (CH); Constructor Education and Research Genossenschaft, Schaffhausen (CH)

(72) Inventors: Svetlana Dergacheva, Sofia (BG); Laurent Dedenis, Geneve (CH); Stanislav Protasov, Singapore (SG); Serg Bell, Singapore (SG); Nikolay Dobrovolskiy, Alanya (TR)

(21) Appl. No.: 19/175,003

(22) Filed: Apr. 10, 2025

(51) Int. Cl. G09B 5/06; G06F 16/906; G06F 16/9535; G09B 7/00

(52) U.S. Cl. CPC G09B 5/06; G06F 16/906; G06F 16/9535; G09B 7/00

(57) ABSTRACT

Disclosed herein are systems and method for providing personalized learning content, comprising: receiving different types of learning materials related to a plurality of concepts or topics; receiving personal learning parameters of a plurality of learner users; dividing the learning materials into content chunks using a machine learning model, wherein each content chuck includes portions of different types of learning materials that are related to the same concept or topic; personalizing the chunks for each user, using the machine learning model, based on the personal learning parameters of each user; determining an importance level of each chunk of each user, using the machine learning model, based on the learning parameters of each user; selecting, for each user, a first personalized subset of the chunks based at least on the importance level of the chunks for that user; and providing the subset of chunks to each user.

### FIELD OF TECHNOLOGY

The present disclosure relates to the field of machine learning, and, more specifically, to systems and methods for using machine learning to personalize educational content.

### BACKGROUND

With the growing popularity of remote learning, many educational institutions have begun offering their courses online and conducting virtual classes and lectures via meeting hosting platforms, such as Zoom. Typically, teachers post their learning materials in a presentation format, accompanied by a video or audio recording of the lecture. Student users connect via their computing devices, such as laptop computers, to the meeting hosting platform to view the presentation and accompanying lecture. However, existing presentation hosting platforms have limited functionality, as they lack the technical capability to personalize learning materials for different student users, format them for various user devices, manage the consumption of learning materials by student users, and effectively administer assessments of students' knowledge.

### SUMMARY

To addresses the shortcomings of conventional remote learning systems described above, the present disclosure provides a system and methods for personalized learning content management with the assistance of artificial intelligence and machine learning technologies. In one aspect, a system receives learning materials (e.g., text, audio, video, etc.) from a teacher user and uses a trained machine learning model (MLM) to divide the learning materials into a plurality of content chunks and personalize the content chunks for different student users and their devices based on personal learning parameters of each student user, user device parameters of each student user, and other criteria. The system may also use a trained MLM to assign a relative importance level to content chunks of each user based on personal learning parameters of each student user. The system then use a trained MLM to generate assessments (e.g., tests) for some of the content chunks of each student user. The system then monitors consumption of the content chunks by the student users, provides the associated assessments to their respective user devices, determining whether the content chunks and their associated assessments have been consumed by student users, and if so, provides additional content chunks to student users.

Unlike some existing remote learning systems that require all student users to consume the same sequence of learning materials and complete the same course assessments, the present system personalizes the gradual presentation and consumption of learning materials according to the individual learning track of each user, user's learning goals and performance on assessments. As a result, while the system may require a less knowledgeable student user to consume and pass assessments of every content chuck, the system may allow a more knowledgeable user to quickly browsing and even skipping some of the learning materials w/o passing assessments. Further, unlike existing remote learning system that provide the same presentation of the learning materials irrespective of user devices which may have different screen sizes, CPU capabilities and memory/storage capacity, the present system generates and personalizes content chunks that are configured according to specific user device parameters.

By efficiently providing content chunks of learning materials that are personalized for different users, the present system greatly enhances and personalizes the learning experience for the student users. Specifically, for example, the less knowledgeable student users are provided with slower pace of content consumption and more time to complete their content chunks, while the more knowledgeable student users are provided with faster pace and more time saving to complete their content chunks. Further, since the subsets of the content chunks are downloaded and consumed gradually, the present system allows for significant reduction in network bandwidth, CPU and memory usage of user devices. Accordingly, the learners may use a simpler/less resource intensive device to view the presentation while still being able to eventually consume the entirety of the learning materials.

In an aspect, a method for providing personalized learning content comprises: receiving different types of learning materials related to a plurality of concepts or topics; receiving personal learning parameters of a plurality of learner users; dividing the learning materials into a plurality of content chunks using a machine learning model, wherein each content chuck includes one or more portions of different types of learning materials that are related to the same concept or topic; personalizing the content chunks for each user, using the machine learning model, based at least on the personal learning parameters of each user; determining an importance level of each one of the plurality of content chunks of each user, using the machine learning model, based on the learning parameters of each user; selecting, for each user, a first personalized subset of the plurality of content chunks based at least on the importance level of the plurality of content chunks for that user; and providing the first personalized subset of the plurality of content chunks to each user.

In one implementation, the method may further comprise: receiving device parameters for one or more computing device of each user; personalizing the content chunks for each of the one or more devices of each user, using the machine learning model, based on corresponding device parameters; receiving a request for learning materials from one of the devices of the user; selecting a first personalized subset of plurality of content chucks for said device; and providing the first personalized subset of the plurality of content chunks to the device.

In one implementation, dividing the learning materials into a plurality of content chunks, personalizing the content chunks, and determining the importance level of the content chunks is performed by two or more different machine learning models.

In one implementation, the method may further comprise: receiving user feedback from a user; using the machine learning model to re-divide the learning materials into the plurality of content chunks for the user based on the user feedback, the personal learning parameters of the user, and their user device parameters; and using the machine learning model to re-determine the importance level of each one of the plurality of content chunks of the user based on the user feedback and the learning parameters of that user.

In one implementation, the method may further comprise: generating an assessment for one or more content chunks, using the machine learning model, based on the importance level of the one or more content chunks, wherein the assessment includes one or more questions that tests a user's knowledge and/or understanding of an associated content chunk.

In one implementation, the method may further comprise: providing, to the user's device of each user out of the plurality of users, the assessment associated with each content chunk in the first personalized subset of the plurality of content chunks.

In one implementation, the method may further comprise: determining that the first personalized subset of the plurality of content chunks and their associated assessments have been successfully consumed by a user; and responsive to the first personalized subset of the plurality of content chunks and their associated assessments having been successfully consumed by the user, providing a second personalized subset of the plurality of content chunks and their associated assessments to the user's device.

In one implementation, determining that the first personalized subset of the plurality of content chunks and their associated assessments have been successfully consumed by the user comprises: for one or more first content chunks having associated relative importance levels that are more than a threshold, verifying successful consumption of the one or more first content chunks and their associated assessments; and for one or more second content chunks having associated relative importance levels that are less than or equal the threshold, skipping verification of successful consumption of the one or more second content chunks and their associated assessments.

In one implementation, the different types of materials include: text, audio, and/or video materials.

In one implementation, using the machine learning model to divide the learning materials into the plurality of content chunks further includes: using the machine learning model to identify a plurality of similar concepts and/or topics within each type of the learning materials, and, when dividing the learning materials into the plurality of content chunks, include in each content chunk each type of material related to a similar concept and/or topic.

In one implementation, the personal learning parameters of a user include learning track, learning goals, and/or learning performance associated with the user.

In one implementation, the device parameters of a user's device comprise at least a screen size of the user's device, and wherein each content chunk is configured to fit within one page on a screen of the user's device.

In one implementation, the method may further comprise: personalizing the content chunks for each user, using the machine learning model, based on a grade level of each user.

It should be noted that the methods described above may be implemented in a system comprising at least one hardware processor and memory. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations. Like reference numbers and designations in the various drawings indicate like elements.

FIG. 1 illustrates a network diagram in which a system for personalized learning content management operates according to aspects of the present disclosure.

FIG. 2 is a block diagram illustrating a system for personalized learning content management according to aspects of the present disclosure.

FIGS. 3A and 3B illustrate various examples of the personalized learning content chunks, according to aspects of the present disclosure.

FIG. 4 is a hybrid flow and block diagram of operation of the system for personalized learning content management, according to aspects of the present disclosure.

FIGS. 5A-5D include a flow diagram of a method system for personalized learning content management, according to aspects of the present disclosure.

FIG. 6 is a block diagram illustrating a system for preparing one or more machine learning models of the learning content management system, according to aspects of the present disclosure.

FIG. 7 is an example of a general-purpose computer system on which aspects of the present disclosure can be implemented.

### DETAILED DESCRIPTION

Exemplary aspects are described herein in the context of a system, method, and computer program product for personalized learning content management. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Turning now to the figures, example aspects are depicted with reference to one or more components described herein, where components in dashed lines may be optional.

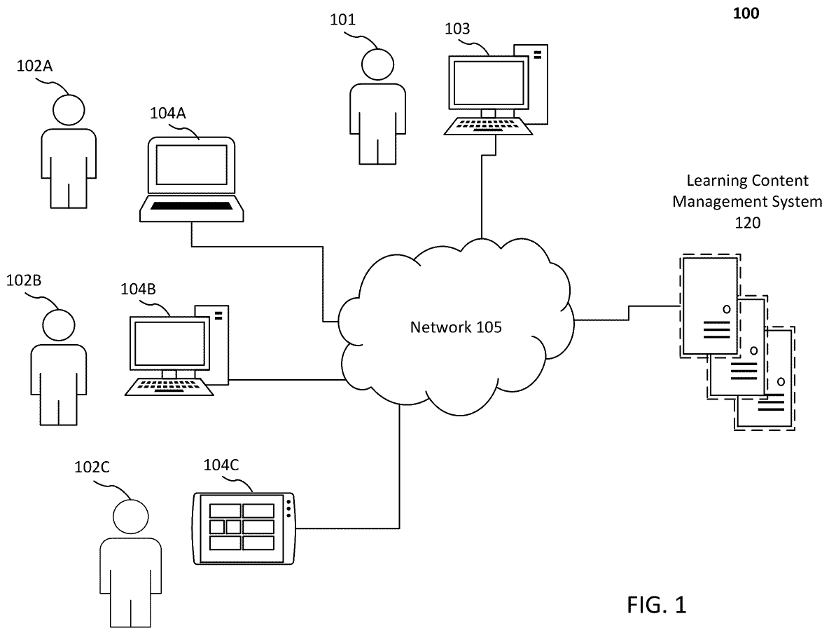

FIG. 1 is a block diagram illustrating a network system 100 that includes a learning content management system 120 deployed on a network server (such as a cloud server) that allows a teacher user 101 to provide personalized educational content (such as academic course materials) to a plurality of student users 102A, 102B, 102C (also referred herein as learners or employees) and to manage content consumption by the plurality of student users 102A, 102B, 102C, according to aspects of the present disclosure. Specifically, the teacher user 101 may use his computer system 103 to connect via network 105 (such as the Internet) to the learning content management system 120 and to create or upload to system 120 various learning materials using user application (now shown) installed on the user device 103 or via a web-based user interface of the system 120 (not shown). The student users 102A, 102B, 102C use their respective user devices 104A, 104B, 104C to connect to the system 120 via the network 105 in order to consume the learning materials that are managed by the system 120. The expression “consuming learning materials” refers to viewing, reading and/or listening.

Although only users 101, 102A, 102B, 102C are illustrated in FIG. 1, the present aspects are not so limited, and many more individual users or organizations may be supported by the system 120. Further, although only user devices 103, 104A, 104B, 104C are illustrated in FIG. 1, the present aspects are not so limited, and any number/type of user devices may be available to each user and used alone or in combination by each user 101, 102A, 102B, 102C. For example, each one of the users 101, 102A, 102B, 102C may have access to one or more devices such as laptops and PCs with different operating systems (e.g., Windows, macOS, Linux, etc.), smartphones (e.g., Android, IOS, etc.), tablets (e.g., Android, IOS, etc.), virtual and augmented reality devices (VR/AR), digital whiteboard, etc. The system 120 may use one or any combination of user devices to provide personalized educational content to users 102A, 102B, 102C.

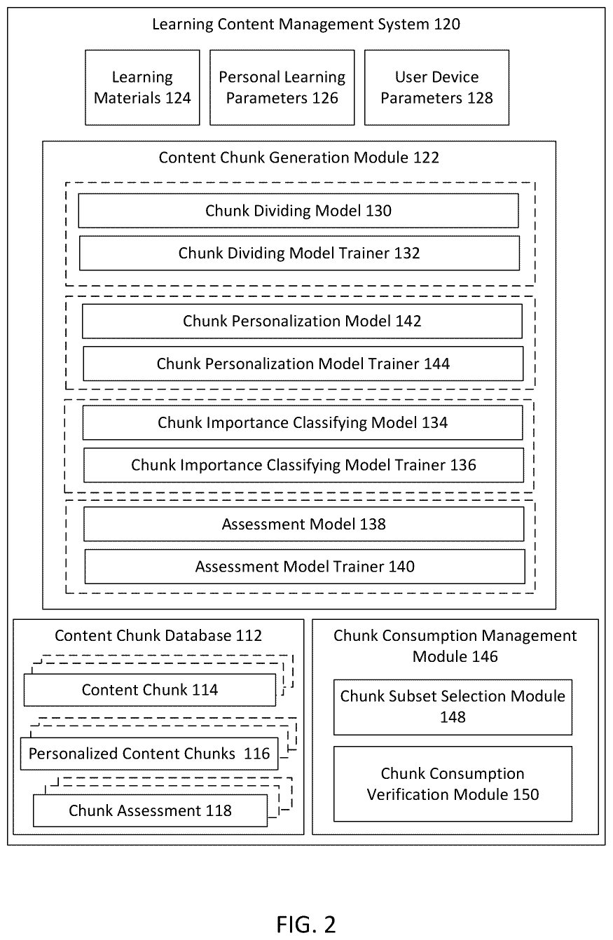

FIG. 2 is a block diagram illustrating the learning content management system 120 according to aspects of the present disclosure. In general, the system 120 facilitates personalization of learning materials for student users 102A, 102B, 102C (commonly referred hereinafter as student users 102 or learners 102), manages consumption of the learning materials by student users 102, and automates the assessment of student users' 102 knowledge of the consumed learning material. In one aspect, the system 120 includes a content chunk generation module 122 that receives learning materials 124 from the teacher user 101, personal learning parameters 126 of student users 102, and user device parameters 128 of each user device 104A, 104B, 104C. The module 122 uses a chunk dividing model 130, which may be a trained machine learning model (MLM), to analyze the learning materials 124 and divide them into a plurality of content chunks 114, which are then stored in the database 112.

Next, the module 122 uses chunk personalization model 142, which may be a trained MLM, to personalize the content chucks 114 for each student user 102 based on personal learning parameters 126 of each student user and/or based on user device parameters 128 of user devices 104. Next, the module 122 uses a chunk importance classifying model 134, which may be a trained MLM, to assign an importance level to each one of the content chunks 116 based on personal learning parameters 126 of each user 102. Next, module 122 uses an assessment module 138, which is a trained MLM, to generate chunk assessment 118 (e.g., tests) for one or more of the content chunks 116 based on their assigned importance levels. Next, the module 122 stores in the database 112 the content chunks 116 for each student 102 along with the respective assigned chunk importance levels, as well as chunk assessments 118 for each content chunk 116. Finally, content chunk consumption management module 146 provides the content chunks 116 and associated assessments 118 to the student users 102 according to their respective levels of importance and manages consumption of the content chunks 116 by the users 102.

More specifically, a teacher user 101, during the initial registration with the system 120 or during subsequent use thereof, may upload from his user device 103, via the user interface of the system 120, the learning materials 124 for a specific class, course or program of study. The teacher user 101 may be an individual or organization (such as tutoring service, school, college, corporation, government agencies, etc.). The learning materials 124 may be in various fields of study (e.g., mathematics, sciences, literature, coding, engineering, philosophy, etc.). The learning materials 124 may be of different types, including, but not limited to, presentation slides, typed notes, outlines, books, research papers, photos, charts, diagrams, video and/or audio recordings and lectures, tests, quizzes, etc.). The learning materials 124 may also be in various formats, such as text (e.g., TXT, PDF, DOC, HTML, CSV), graphics (e.g., JPEG, GIF, BMP, PPT slides, Google Slides), audio recordings (e.g., MP3, WAV, etc.), video recordings (e.g., MP4, AVI, MOV), etc.

In one aspect, a student user 102 during the initial registration with system 120 or during the subsequent use thereof, may select via the user interface (UI) of system 120 one or more of the available academic classes, courses or programs of study (commonly referred hereinafter as courses). For each selected course, the system 120 may prompt the student user 102 to provide various personal learning parameters 126, user device parameters 128, and other optional personal information, which may be used by system 120 to personalize learning content provided to the user 102. In one aspect, personal learning parameters 126 of the student user 102 may include, but not limited to, information about user's learning track (e.g., grade level, educational background, field of study, major or minor, area of concentration, completed course, etc.), information about user's learning goals (e.g., target grade point average (GPA), desired field of knowledge, desired profession, desired skillset, etc.), information about user's academic performance (e.g., grades on tests and quizzes in the current course, grades in the completed related courses, grades in laboratory exercises, etc.). In another optional aspect, the student user 102 may also provide information about his language preferences (e.g. English, Spanish, Chinese, etc.) and grade level at which material has to be presented (e.g., kindergarten, elementary school, high school, college, professional school, etc.)

In yet another aspect, the system 120 may collect user device parameters 128 of user devices 104A, 104B, 104C, which student users 102A, 102B, 102C may use to consume learning materials 124. The user device parameters 128 may be collected by software agents of the system 120 deployed on the user device 104A, 104B, 104C (e.g., browser extension, desktop application, web-based application, or mobile app, etc.), or be provided by the student user 102A, 102B, 102C via the UI of the system 120. The user device parameters 128 may include, but not limited to, device type, screen size, CPU clock speed/utilization, wired/wireless/cellular connection bandwidth, memory/storage capacity, device manufacturer, and/or operating system (OS) type of each device user device 104. The system 120 may use this information to optimize the size and format of the content chunks 114 for each user device 104, in order to deliver the highest possible quality of presentation of the learning materials 124 on each user device 104 while maintaining optimal performance and stability of the user device 104.

### Generation of Content Chunks

In one aspect, the content chunk generation module 122 of the system 120 receives learning materials 124 from the teacher user 101, personal learning parameters 126 of student users 102A, 102B, 102C, and user device parameters 128 of each user device 104A, 104B, 104C, and uses this data to generate a plurality of content chunks 114. In particular, the module 122 uses a chunk dividing model 130, which may be a trained machine learning model (MLM), to analyze the learning materials 124 and divide them into a plurality of content chunks 114. In one aspect, the model 130 performs a natural language processing (NLP) of the learning materials 124 to identify various concepts and topics contained therein. NLP algorithms analyze the syntactic and semantic structure of the text to understand the relationships between words and phrases. For example, model 130 may utilize named entity recognition (NER) to identify identifying and categorizing key information mentioned in the learning materials 124. The model 130 then extracts all conceptually-related portions of the learning materials 124 and combines the extracted portions, e.g., in their original file formats (e.g., PPT, MP4, MP3, TEXT, etc.), into a storage data structure, such as a file, a file folder, or an archive (e.g., XML file, ZIP file, PPT file). This data structure is a content chunk 114. In one aspect, the chunk dividing model 130 initiates the analysis and division of the learning material 124 into the content chunks 114 automatically, without any specific prompts from the teacher user 101.

In another aspect, the model 130 may convert some of the content portions, before grouping them into content chunks 114, into different file formats, that are more convenient for processing, styling/formatting/editing, displaying or storing than their original file format. For example, model 130 may convert PDF documents into MS DOCX format, which is widely used for text documents and supports rich text formatting, images, and other multimedia elements. Also, DOCX format allows easier styling and formatting of text document than PDF for display on different user devices. Model 130 may convert Google Slides into the more popular MS PowerPoint (PPT) format. Model 130 may convert Apple's AAC and ALAC audio files into the more universal MP3 format. Model 130 may convert MOV video files into the more universal and compact MP4 format. At this time, model 130 may also resize large files (e.g., image files, video files, etc.) into smaller-sized files to reduce storage usage. In addition, model 130 may transcribe audio files and store the transcripts in a text format. Moreover, model 130 may translate contents in foreign languages into the English or other languages specified by the teacher user 101. Model 130 may then create an archive file containing all content portions of each content chunk 114.

To summarize, the content chunk 114 includes a collection of conceptually-related portions of learning material 124 (in the original file format or reformatted) of various types (such as text, audio, video, graphics, multimedia, etc.) sourced from different origins (e.g., course curriculum, textbooks, presentation slides, audio or video lectures, teacher's notes, outlines, tests, etc.) provided by the teacher user 101 and/or obtained from external sources (e.g., the Internet, online encyclopedias, digital publications, code libraries, etc.). This content is grouped together into a content chunk 114, by model 130, based on similarity of subject matter to focus on a distinct learning concept or topic. This approach allows a corpus of learning materials 124 to be organized into multiple conceptually-related content chunks 114. This organization enhances the quality of material presentation to users 102, facilitates their comprehension, and enables focused testing of each user's knowledge of the material by chunk.

For example, a teacher user 101 (e.g., a college physics professor) uploads into the learning content management system 120 learning materials 124 for a general physics course that they are administering online to a plurality of registered student users 102. The learning materials 124 may include, but are not limited to, a course title and description, course curriculum, course objectives and learning outcomes, a list of textbooks, instructional materials (such as presentation slides from various lectures and video recordings of the lectures), assessment materials (such as tests and quizzes), and information about external knowledge sources (such as online tools and library resources). Additionally, the teacher user 101 may provide the system 120 with information about the student users 102 registered for his physics course (e.g., names, usernames and emails), as well as some personal learning parameters 126 of the student users 102, such as their grades on tests and labs for the course, grades from related courses (such as chemistry, calculus, electrical engineering, etc.), and their field of study.

The content chunk generation module 122 uses the chunk dividing model 130 to analyze, for example, the course curriculum document included in the learning materials 124 of the physics course, and to identify, for example, the following topics listed therein: Kinematics, Dynamics and Work and Energy, as well as the following subtopics for each topic:

| Kinematics | Dynamics | Work and Energy |
|---|---|---|
| Motion in One Dimension | Newton's Laws of Motion | Work Done by a Force |
| Motion in Two Dimensions | Application of Newton's Laws | Kinetic and Potential Energy |
| Projectile Motion | Frictional Forces | Conservation of Energy |
| Relative Motion | Circular Motion, Gravitation | Power |

The chunk dividing model 130 then perform NLP and semantic analysis on each type of received material content 124 to identify distinct content portions conceptually-related to each of the respective topics/subtopics. For example, the model 130 analyzes all presentation slides within learning materials 124 and identifies portions of presentation slides related to Projection Motion subtopic. The model 130 then analyzes digital textbooks and research papers within the learning materials 124 and identifies portions related to Projection Motion subtopic. The model 130 then analyzes video and audio lectures within learning materials 124 and identifies portions related to Projection Motion. The model 130 then analyzes practice questions within learning materials 124 and identifies questions related to Projection Motion. The model 130 performs the same NLP and semantic analysis on all available types of the learning materials 124 to identity all content portions conceptually-related for the Projection Motion subtopic.

Next, the model 130 extracts these conceptually-related portions of the learning materials 124 and groups them, in their original file formats or reformatted, into an archive file (e.g., ZIP file) to form a content chunk 114. In this manner, the model 130 generates the content chunk 114 containing all portions of learning materials 124 related to the Projection Motion subtopic of the Physics course. Next, the chunk dividing model 130 analyzes the rest of the learning materials 124 and identifies portions related to other topics/subtopics of the physics course, such as Motion in One Dimension, Frictional Forces, Conservation of Energy, etc., and extracts all portions of learning materials 124 conceptually related to each of the identified subtopics, and groups the extracted portions into the separate content chunks 114.

In one aspect, the chunk dividing model 130 may include one or more trained machine learning models (MLMs), such as a large language model (LLM). An LLM is an advanced artificial intelligence system designed to understand and generate human-like text. These models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through preparing (which may include training, retraining, distillation, fine-tuning, etc.) to teach each LLM model to perform their respective specific tasks. As a non-limiting example, the LLM models may incorporate one of the machine learning models listed below.

Typically, a LLM comprises a deep neural network that has a transformer architecture. Neural networks are a class of machine learning models inspired by the structure and functioning of the human brain. They consist of interconnected nodes, called neurons, or artificial neurons, organized into layers. Neural networks are capable of learning complex patterns and representations from data. A transformer-based neural network has an encoder/decoder structure with numerous stacked multi-head attention layers and feed forward network layers (e.g., neural networks). This architecture allows the model to process and generate text effectively, capturing long-range dependencies and contextual information. Transformers are well-suited for tasks like natural language processing and image classification and generation. Common examples of transformer models are generative pre-trained transformers (GPTs) and Bidirectional Encoder Representations from Transformers (BERTs).

In other aspects, the chunk dividing model 130 may include other types of MLMs for analyzing and dividing the learning materials 124 into a plurality of conceptually-related content chunks 114. Such other types of MLMs may include: convolution neural networks (CNNs), recurrent neural networks (RNNs), long short-term memory (LSTM) networks, gated recurrent unit (GRU) networks, autoencoders, and generative adversarial networks (GANs). Each of these neural networks employ different types of learning (such as supervise or unsupervised learning), have different architectures, and various applications, such as NLP, image recognition, image generation, speech recognition, video processing, language translation, etc.

A CNN is specialized for processing grid-like data, such as images, and employs convolutional layers to learn spatial hierarchies of features, reducing the need for manual feature engineering. CNNs are well-suited for tasks like image classification, object detection, and image generation. An RNN is designed for sequential data, where the order of inputs matters. An RNN includes loops in the network architecture to allow information to persist, and is useful for tasks like natural language processing, speech recognition, and time-series prediction. An LSTM network is an extension of an RNN designed to overcome the vanishing gradient problem. LSTMs have memory cells that can store and retrieve information over long sequences, making them effective for capturing long-term dependencies in sequential data. A GRU network is similar to LSTMs and is another type of RNN with mechanisms to address the vanishing gradient problem. GRUs have a simpler architecture with fewer parameters compared to LSTMs. An autoencoder is a type of neural network used for unsupervised learning and dimensionality reduction, and consists of an encoder that compresses input data into a lower-dimensional representation (encoding) and a decoder that reconstructs the original input from the encoding. A GAN comprises a generator and a discriminator trained simultaneously through adversarial training. The generator aims to generate realistic data, while the discriminator tries to distinguish between real and generated data. A GAN is widely used for image and content generation tasks.

In various aspects, the chunk dividing model 130 may use various techniques and tools in conjunction with the MLMs to extract portions of text, audio or video files from learning material 124. For example, Automatic Speech Recognition (ASR) software may be used to convert spoken words in audio files into text. This text can then be processed by a LLM to identify concept specific text portions based on content. In addition, various commercial speech recognition tools, such as Google Speech-to-Text, IBM Watson Speech to Text, and Amazon Transcribe, may be used. Natural Language Processing (NLP) may be used to analyze the transcribed text from audio or video files to identify keywords, topics, or concept-specific text segments. Computer vision tools such as OpenCV, TensorFlow, and PyTorch, may be used to analyze video content to detect objects, scenes, segments or for facial recognition. Video editing software or custom scripts may be used to handle timestamp-based extraction in transcripts or metadata to locate and extract specific portions of audio or video files. The model 130 may also integrate LLMs with audio or video editing software, such as Adobe Premiere Pro, Final Cut Pro, or custom scripts, to automate extraction of audio and video content from learning material 124. By combining trained MLMs with these techniques and tools, model 130 can efficiently extract concept-specific portions of audio or video files based on analysis of learning material 124.

In one aspect, a chunk dividing model trainer 132 may be used to prepare an untrained MLM or fine-tune a trained MLM utilized by the model 130. To that end, a MLM may be trained or fine-tuned using a training dataset to “learn” how to divide the learning materials 124 into content chunks 114. As an example, the training dataset may include at least: a plurality of documents comprising learning materials associated with various educational courses, a plurality of appropriate content chunks generated by dividing the documents into a plurality of conceptually-related portions, and a plurality of inappropriate chunks generated by dividing the documents into conceptually-unrelated portions. During preparing (which may include training, retraining, distillation, fine-tuning, etc.), the training dataset are input into the MLM. The results from the MLM are then compared with known dataset results using the corresponding labels identifying the type of chunks (e.g., appropriate chunks of conceptually-related portions or inappropriate chunks of conceptually-unrelated portions).

For every input training sample from the training dataset, the MLM will produce a prediction consisting of values representing a probability that particular learning materials are correctly divided into content chunks. The trained MLM then uses a loss function that quantifies the error between the predicted output and the ground truth for a given training sample. In other words, the loss function can be used to guide the learning process by updating the neural network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the LLM is trained, the trained MLM may be used for inference, e.g., for dividing the learning materials 124 into appropriate chunks containing conceptually-related portions. During inference, the trained MLM does not re-evaluate or adjust the layers of the neural network based on the results. Instead, the inference applies knowledge from the trained neural network and uses it to infer a result (e.g., identify appropriate content chunks for various types of material containing various topics and concepts). Accordingly, when a new unknown dataset (e.g., new learning materials) is input through the trained neural network, the trained MLM outputs a prediction of an accuracy of dividing the learning materials into a plurality of conceptually-related content chunks 114 based on predictive accuracy of the MLM.

One skilled in the art will appreciate that the MLMs utilized by chunk dividing model 130 may have significantly large datasets with highly specific details. For example, the MLM may be trained to identify key points/concepts/topics in the learning materials 124 and divide the learning materials 124 into a plurality of conceptually-related content chunks 114, such that each content chunk includes the learning materials associated with one concept or topic, e.g., one concept or topic per content chunk 114. As another example, the learning materials 124 may include a large amount of data including textbooks that need to be analyzed by the MLM to identify significant/important ideas and generate one learning content chunk per idea. This type of analysis would be beyond the capabilities of the human mind because the amount of data to be identified, considered, and processed is unfathomable.

### Personalization of Content Chunks

After dividing the learning materials 124 into the plurality of content chunks 114, the content chunk generation module 122 uses a chunk personalization model 142 to personalize the plurality of content chucks 114 for each student user 102 and/or user device 104. In one aspect, the chunk personalization model 142 utilizes one or more trained MLMs (such as a LLM and/or other types of models described above) to personalize the content, format and/or size each content chunk 114 for presentation to the student user 102 on user device 104 based on personal learning parameters 126 of each student user 102, based on user device parameters 128 of a user device 104 of each user 102, and/or based on other criteria. The personalization of content chunks 114 is generally aimed to optimize the content, format and/or size of each content chunk 114 for each student user 102 and user device 104, in order to deliver the highest possible quality of presentation of the learning materials 124 to each user device 102 while maintaining optimal performance and stability of the user device 104.

In one aspect, the chunk personalization model 142 may personalize content chunks 114 based on personal learning parameters 126 of each student user 102, including, but not limited to, information about user's learning track (e.g., grade level, educational background, field of study, major or minor, area of concentration, completed courses, etc.), information about user's learning goals (e.g., target grade point average (GPA), desired field of knowledge, desired profession, desired skillset, etc.), information about user's academic performance (e.g., grades on tests and quizzes in the current course, grades in the completed related courses, grades in laboratory exercises, etc.). In another optional aspect, the personalization of content chunks 114 may be based on student user's language preferences (e.g. English, Spanish, Chinese, etc.) and/or grade level at which material has to be presented to the student user (e.g., kindergarten, elementary school, high school, college, professional school, etc.)

For example, if the learning track parameter 126 of student user 102A indicates that the student user 102A majors in Physics, the chunk personalization model 142 may be configured to automatically modify relevant content chunks 114 for the General Physics course for the student user 102A to include references to related physics courses required by the Physics major, such as Electromagnetism, Quantum Mechanics, Solid State Physics, etc. This modification will provide the student user 102A with a broader understanding of how specific topics discussed in the content chunks 114 of General Physics course relate to the other courses within his major. To accomplish this, the chunk personalization model 142 may utilize a trained LLM to analyze the curriculum of the Physics major to identify courses related to the General Physics course and then modify the content chunks 114 of General Physics course with references to related courses.

In another example, if the learning track parameter 126 of student user 102B indicates that the student user 102B majors in Physics with a minor in Chemistry, the chunk personalization model 142 may be configured to modify content chunks 114 related to the Thermodynamics topic, which deals with concepts of heat, work, energy, and the laws of thermodynamics, which are crucial for studying chemical reactions and equilibrium, with the additional examples of chemical reactions (e.g., melting, boiling, and sublimation), which are essential to the Chemical Reactions course required by the Chemistry minor. This will help student user 102B to better understand relationship between physical and chemical processes. To accomplish this, the chunk personalization model 142 may utilize a trained LLM to analyze the curriculum of the Physics and Chemistry majors to identify related courses and then modify the content chunks 114 of General Physics course with references to related Chemistry courses.

In another example, if the learning goals parameter 126 of student user 102C indicates that the student aims to achieve a GPA of 3.5 or higher (on a 4.0 grading scale) in the General Physics course, the chunk personalization model 142 may be configured to automatically generate supplemental study materials from learning materials 124 or external sources (such as online resources) and/or additional knowledge assessment questions for each topic of the General Physics course. The model 142 may then automatically add the generated supplemental reading materials and knowledge assessment questions to all or some content chunks 114 for student user 102C. These resources will help student user 102C to better prepare for the tests. To accomplish this, the chunk personalization model 142 may utilize a trained LLM to analyze learning materials 124 and/or other sources of knowledge, to generate supplemental reading materials from these sources and/or additional knowledge assessment questions, and add these materials and questions to the relevant content chunks 114 of student user 102C.

In another example, if the user's academic performance parameter 126 of student user 102A indicates that the student's grades on the tests and quizzes in the General Physics course are unsatisfactory (below GPA of 2.5), the chunk personalization model 142 may be configured to automatically add to the relevant content chunks 114 supplemental reading materials from external sources (such as textbooks or online resources), additional lecture videos provided by teacher user 101, and/or additional knowledge assessment questions for each content chunk 114 in which the user received poor grades. The model 142 may then automatically add the generated supplemental content to the relevant content chunks 114 for student user 102A. These resources will help user 102A to improve test performance. To accomplish this, the chunk personalization model 142 may utilize a trained LLM to analyze learning materials 124 and/or other sources of knowledge, to generate supplemental reading and/or video materials, and/or additional knowledge assessment questions, and add these materials and questions to the relevant content chunks 114 of student user 102A.

In another example, if the language preference parameter 126 of student user 102B indicates that the student prefers to consume learning material in a language other than English (e.g. Spanish, Chinese, etc.), the chunk personalization model 142 may be configured to automatically translate all content chunks 114 for student user 102B from English into the preferred language. This may be done to both the text, audio and video content. To accomplish this, the chunk personalization model 142 may utilize a trained LLM for content translation.

In another example, if the grade level parameter 126 of student user 102C indicates that the student is in middle school and is taking the online General Physics course as a recreational activity rather than a mandatory academic requirement, the chunk personalization model 142 may be configured to automatically adjust the content chunks 114. This includes removing knowledge assessments, simplifying vocabulary by using more common words and avoiding jargon or complex terminology, shortening sentences and using straightforward sentence structures, providing concrete examples and familiar concepts while avoiding abstract ideas that may be difficult for younger readers to grasp, and using a friendly and engaging tone to maintain the interest of younger readers. These personalizations of the content chunks 114 for the young student user 102C will make the material more suitable for the age and education level of a middle school student compared to a college student. To accomplish this, the chunk personalization model 142 may utilize a trained LLM for content analysis and modification.

In one aspect, the chunk personalization model 142 may personalize all or individual content chunks 114 for display on various devices 104 of the student user 102A or devices of other users 102B and 102C based on the device parameters 128 of the respective user devices. The device parameters 128 may include, but not limited to, a type of the user device (e.g., smartphone, tablet, laptop or desktop), screen size, CPU clock speed and utilization, wired/wireless/cellular connection bandwidth, memory/storage capacity, device manufacturer, operating system, or any other known information about the user device 104. The model 142 may utilize a trained MLM to analyze all available device parameters 128 to select an optimum format and size of each content chunk 114. In one aspect, the model 142 may select the suitable format from one of predefined format templates generated by the MLM or coded by the system developers using, e.g., HTML, XML, Java or C++ programming languages. In one aspect, the dimensions of these templates may be dynamically adjusted to fit one page of the device screen.

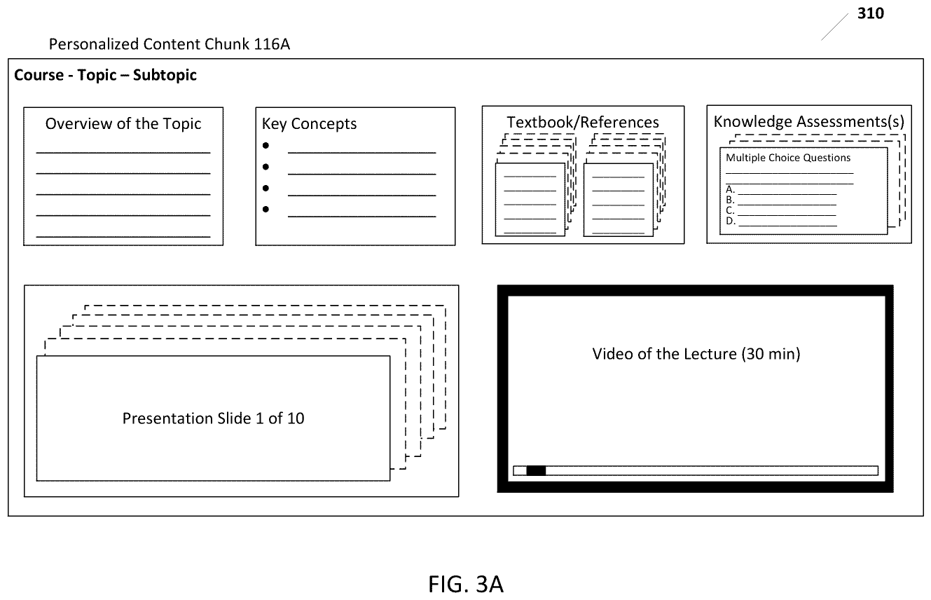

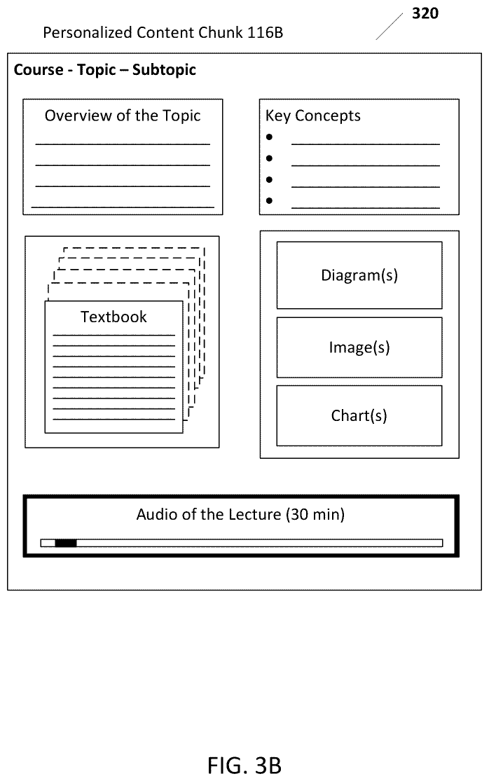

FIGS. 3A and 3B illustrate examples of two possible format templates for personalized content chunks 116 based on various device parameters 128. For example, a landscape format template 310 may be used to personalize content chunks 116A for laptops or desktop computers, which generally have large screens/monitors (e.g., greater than 11 inches in diagonal) capable of displaying large amount of content. Also, these devices typically feature powerful CPUs (e.g., Intel Core i5), sufficient RAM (e.g., 16 GB), and ample data storage (e.g., 2 TB) to support multimedia-rich personalized content chunks 116A. Such personalized content chunks 116A may include several text sections (such as an Overview of the Topic and Key Concepts), framed or embedded textbook portions in the PDF or TEXT format, embedded PowerPoint presentation of the lecture, an embedded video of the lecture, interactive multiple-choice knowledge assessment questions, and other types of static, dynamic and interactive content. The size of content chunk 116A may range from 2 to 3 GB and can be smoothly executed on a powerful laptop or PC user device 104.

In another example, a portrait format template 320 may be used to personalize content chunk 116B for a smartphone or small tablet device, which typically has a smaller screen size (e.g., less than 11 inches in diagonal) compared to laptops and desktop computers. These devices also have less powerful CPUs (e.g., Snapdragon 600), less RAM (e.g., 4 GB), and less data storage (e.g., 256 GB), and thus cannot effectively display and execute large, multimedia-rich content chunks like 116A. However, these user devices 104 may be sufficient to display and execute smaller content chunk 116B, which contains fewer dynamic and interactive elements. For example, the chunk personalization model 142 may include in the content chunk 116B a smaller-sized MP3 audio of the lecture instead of embedding a significantly larger MP4 video of the same lecture. In this case, the size of the content chunk 116B may range from 200 to 500 MB and can be smoothly executed on an average smartphone or tablet user device 104.

In one aspect, the chunk personalization model 142 may use a trained MLM (such as a LLM) to personalize the styling and size of individual elements within templates 310 and 320 to make sure that all content of chunk 116 fits within one page on the screen of the user device 104. For example, for text elements, model 142 may identify key topics, headings, and subheadings, and apply appropriate formatting and styling to each type of text, such as font selection, size, color, and alignment to optimize the readability of text for each user device 104. For images and videos, model 142 determines where they fit within the template 310 or 320 based on context and relevance, determines the placement and size of images and video thumbnails within the template 310 and 320, and sizes all multimedia elements to ensures that are appropriately captioned and aligned with the related text content of the template 310 and 320.

In another aspect, the chunk personalization model 142 may use a trained MLM (such as a LLM) to reduce the file size of text and multimedia elements within content chunk 114 to ensure that the overall file size of each personalized content chunk 116 does not exceed the capacity of the memory and/or data storage of the user device 104. For example, model 142 may modify text to use a concise language and remove unnecessary text to reduce the overall size. It may summarize lengthy sections while retaining key information. For images, model 142 may use photo editing software (such as Adobe Photoshop, GIMP, or online tools like Pixlr or Canva) to compress images using efficient algorithms to reduce file size without significantly compromising quality or adjust image resolution and format (e.g., using JPEG instead of PNG for photographs). For video, model 142 may reformat video files using video editing software (such as Adobe Premiere Pro, Final Cut Pro, HandBrake, or FFmpeg) to reduce high definition (720p) video to standard definition (480p), which will reduce the size of the video file by half.

In one aspect, a chunk personalization model trainer 144 may be used to prepare an untrained MLM or fine-tune a trained MLM utilized by the model 142. To that end, a MLM may be trained or fine-tuned using a training dataset to “learn” how to personalize the content chunks 114 based on various personal user parameters 126 and device parameters 128. As an example, the training dataset may include at least: a plurality of personal learning parameters representing a plurality of users having different learning tracks/goals/performance, a plurality of device parameters representing different types of devices (e.g., different screen sizes), several different format templates (e.g., templates 310 and 320), and a plurality of content chunks. During preparing (which may include training, retraining, distillation, fine-tuning, etc.), the training dataset are input through the untrained MLM. The results from the untrained MLM model are then compared with known dataset results using the corresponding labels identifying the type of personalized chunks (e.g., correctly personalized chunk or incorrectly personalized chunk for a respective user and/or user device).

For every input training sample from the training dataset, the trained MLM will produce a prediction consisting of values representing a probability that a particular content chunk is correctly personalized. The trained MLM then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the MLM is trained, the trained MLM may be used for inference, e.g., for personalizing the content chunks 114 for each user 102 and/or user device 104. During inference, the trained MLM does not re-evaluate or adjust the layers of the neural network based on the results. Instead, the inference applies knowledge from the trained neural network and uses it to infer a result (e.g., identify correctly personalized content chunks for each user and/or user device). Accordingly, when a new unknown dataset (e.g., new learning materials, new user learning parameters, and/or new user device parameters) is input through the trained neural network, the trained MLM outputs a prediction of an accuracy of personalizing a content chunk into a correctly personalized content chunks based on predictive accuracy of the MLM.

### Classification of Importance of Content Chunks

After dividing and personalizing the learning materials 124 into the personalized content chunks 116 an storing them in database 112 the content chunk generation module 122 uses a chunk importance classifying model 134 to determine an importance level for each one of the content chunks 116 based on the personal learning parameters 126 of each user 102. In an aspect, the chunk importance level classifying model 134 may include any MLM described hereinabove. For example, the chunk importance level classifying model 134 may include a large language model (LLM) trained (using a chunk importance level classifying model trainer 136) to determine an importance level of the content chunks 116, based on personal learning parameters 126 of each user 102.

In one aspect, the chunk importance level classifying model 134 may retrieve from content chunk database 112 a personalized content chunk 116 for a user 102A and various personal user parameters 126 of user 102A, such as information about user's learning track, information about user's learning goals, or information about user's academic performance. Model 134 then performs NLP analysis of contents of the content chunk 116, compares them with various personal user parameters 126, and classifies content chunk 116 into, for example, one of three levels of importance, such as high, medium and low. Model 134 then repeats this process for all personalized content chunks 116 of use 102A stored in the database 112.

For example, a content chunk 116 that provides an introduction and background for an educational topic may not have high importance for a graduate or postgraduate student user 102A, in which case model 134 may classify it at a “low” importance level for user 102A. But the same content chunk may have the higher importance for a high school student 102B, in which case model 134 may classify it at a “medium” importance level for user 102B. As another example, a content chunk 116 that provides an introduction and background for an educational topic may not have high importance for a user that has already attended a preliminary course on that subject, in which case model 134 may classify it at a “low” importance level. But the same content chunk may have the highest importance for a user who is exposed to the topic for the first time, in which case model 134 may classify it at a “high” importance level. As yet another example, a content chunk 116 that provides an example of an already consumed topic may not have high importance for a high performing user, and thus may be classified as “low” importance. But the same content chuck may be determined by model 134 as more important for a lower performing user that needs more practice and explaining to learn the topic, in which case, model 134 may classify it at a “high” importance level.

For analysis tasks, such as classifying an importance level of the personalized content chunks 116 based on the personal learning parameters 126 of a respective user 102, an untrained MLM will first analyze data from a training set to “learn” which content chunk is associated with which relative importance level for a user. As an example, the training dataset may include at least: a plurality of content chunks for each of a plurality of users, a plurality of personal learning parameters representing the plurality of users having different learning tracks/goals/performance, a plurality of appropriate importance levels of the content chunks, and a plurality of inappropriate importance levels of the content chunks. During preparing (which may include training, retraining, distillation, fine-tuning, etc.), the training dataset are input through the untrained ML model. The results from the untrained MLM are then compared with known dataset results using the corresponding labels identifying the type of relative importance level (e.g., appropriate or inappropriate relative importance level for a respective content chunk of a respective user). It should be noted that the input to the trained MLM will be data from the training dataset.

For every input training sample from the training dataset, the trained MLM will produce a prediction consisting of values representing a probability that a particular set of relative importance levels are correctly identified. The trained MLM then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the MLM is trained, it may be used for inference, e.g., for identifying the relative importance levels for each personalized content chunk 116 of a user 102. During inference, the trained MLM does not re-evaluate or adjust the layers of the neural network based on the results. Instead, the inference applies knowledge from the trained neural network and uses it to infer a result (e.g., identify relative importance levels for each content chunk of a user). Accordingly, when a new unknown dataset (e.g., new set of learning content chunks and/or new user learning parameters) is input through the trained neural network, the trained MLM outputs a prediction of an accuracy of identification of relative importance levels of the content chunks of a user based on predictive accuracy of the MLM.

### Assessement Generation

After dividing and personalizing the learning materials 124 into the personalized content chunks 116 for each user and/or user device 102, and determining an importance level of each personalized content chunk 116, the content chunk generation module 122 may use an assessment module 138 to generate a chunk assessment 118 (e.g., tests) for one or more personalized content chunks 116 based on their assigned importance levels and check/grade user completed assessments 118. In one aspect, the assessment module 138 may use MLMs described herein to generate and check/grade assessments 118. For example, the assessment module 138 may use a LLM (trained using an assessment generating model trainer 140) to generate a chunk assessment 118 for one or more personalized content chunks 116.

For example, the assessment module 138 may utilize a LLM to perform NLP analysis of the content of a personalized content chunk 116 and generate one or more questions (e.g., multiple choice questions, written response questions, coding exercises, etc.) and corresponding correct answers based on the subject matter discussed in content chunk 116, and combine these questions/answers into one or more assessments 118 for that given content chunk 116. The generated assessments 118 may be stored in the chunk database 112 along with the corresponding content chunk 116.

Here are several examples of assessment questions that can be generated by the assessment module 138. For example, if a content chunk 116 discusses how sound travels in different mediums, the assessment module 138 may generate the following multiple choice question for the chunk 116: “What is the speed of sound in air? (A) 57 m/s, (B) 1481 m/s, (C) 343 m/s, (D) 13 km/h.” The correct answer is (C) 343 m/s. Alternatively, the question may be in a written response form, such as” “Explain how and why the speed of sound changes in different types of media.” The correct system-generated answer is “The speed of sound changes in different types of media due to variations in density and elasticity; it travels faster in solids than in liquids, and faster in liquids than in gases. This is because particles in denser and more elastic media transmit vibrations more efficiently, allowing sound waves to propagate more quickly.”

In one aspect, the assessment module 138 may utilize grading rules to check and grade user-provided responses to multiple choice questions in assessments 118. For example, module 138 may check if the user-provided multiple-choice answer is the same as the system-generated correct answer for that question. In another aspect, the assessment module 138 may utilize LLM to check and grade user-provided written response by performing NLP of the written response and comparing it with system-generated answer for that question. The assessment module 138 may use various response scoring criteria, including but not limited to, accuracy, completeness, relevance, clarity and coherence, grammar and syntax, originality, etc.

For analysis tasks such as generating a chunk assessment 118 for one or more of the personalized content chunks 116 based on their assigned importance level, an untrained ML model will first analyze data from a training set to “learn” which assessment is associated with which content chunk. As an example, the training dataset may include at least: a plurality of content chunks for each of a plurality of users, a plurality of relative importance levels for each content chunk, a plurality of appropriate assessments for the content chunks, and a plurality of inappropriate assessments for the content chunk. During preparing (which may include training, retraining, distillation, fine-tuning, etc.), the training dataset are input through the untrained MLM. The results from the untrained MLM are then compared with known dataset results using the corresponding labels identifying the type of assessment (e.g., appropriate or inappropriate for a respective content chunk and its associated relative importance level). It should be noted that the input to the trained MLM will be data from the training dataset.

For every input training sample from the training dataset, the trained ML model will produce a prediction consisting of values representing a probability that a particular assessment is correctly generated. The trained MLM then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the MLM is trained, the trained MLM may be used for inference, e.g., for identifying an assessment for each content chunk based on their respective relative importance levels. During inference, the trained MLM does not re-evaluate or adjust the layers of the neural network based on the results. Instead, the inference applies knowledge from the trained neural network and uses it to infer a result (e.g., generate an assessment for each content chunk based on their importance levels). Accordingly, when a new unknown dataset (e.g., a new set of content chunks and/or new importance levels) is input through the trained neural network, the trained MLM outputs a prediction of an accuracy of generation of an assessment for each content chunk and their relative importance levels.

### Consumption Management

After personalized content chunks 116 and their assessments 118 are stored in the chunk database 112, learning content management system 120 may execute a chunk consumption management module 146 to manage consumption of the personalized content chunks 116 and associated assessments 118 on a user device 104 of each user 102. In one aspect, the module 146 assures gradual consumption of content chunks 116, so that when the entire learning material 124 is divided into a plurality of personalized content chunks 116, the student user 102 is allowed to consume only one chunk at a time, and only after successfully completing the associated assessment 118 (if any), the module 146 provides a next content chunk 116 to the user 102.

In one aspect, the chunk consumption management module 146 executes a chunk subset selection module 148 that allows the user 102 to select, via a user interface 106 of the user application 105, a subset (one or more) of personalized content chunks 116′ and associated assessments 118′ from the chunk database 112, and downloads them into the storage 110 of the user device 104. In another aspect, instead of downloading a subset of content chuck 116′ to the device 102, the module 146 may stream these content chuck 116′ to the user's device 102. The chunk consumption management module 146 then executes a chunk consumption verification module 150 that verifies successful consumption of the downloaded content chunks 116′ by the user 102. The successful consumption is considered verified when the user completes reading, watching, and/or listening all learning content provided in the content chunk 116′ and successfully completes associated assessment 118′ (e.g., answers at least 85% of questions correctly). Upon successful consumption of first subset of content chunks 116′, the module 146 repeats the selection, downloading, and consumption verification of another subset of the content chunks 116″.

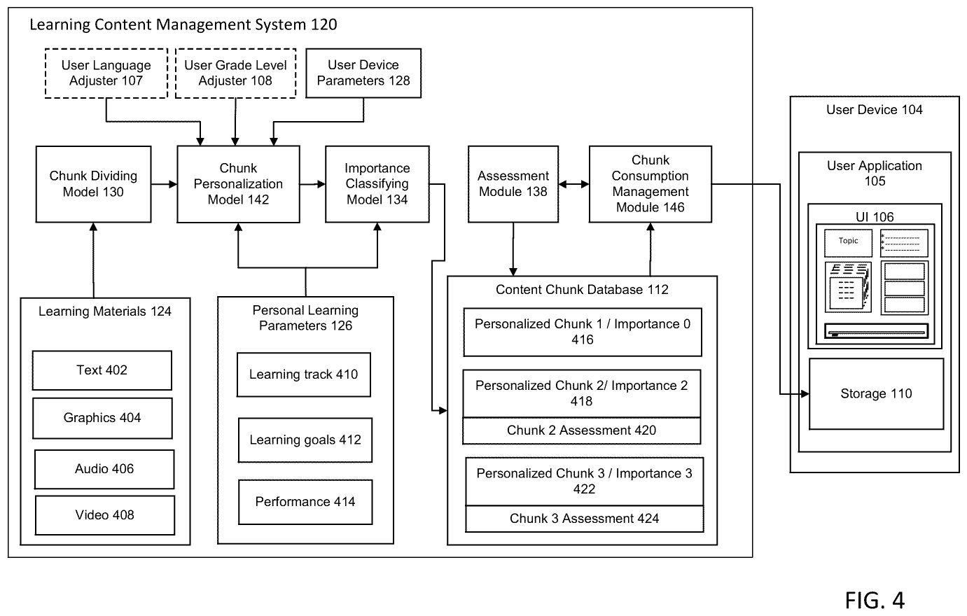

FIG. 4 is a hybrid flow and block diagram of operation of the learning content management system 120, according to aspects of the present disclosure. As shown in FIG. 4, the chunk dividing model 130 in the system 120 receives learning material 124 (e.g., text 402, graphics 404, audio 406, video 408, etc.) and divides them to content chunks as described herein and sends the content chunks to the chunk personalization model 142. The chunk personalization model 142 personalizes the content chunks for each user based on the user's personal learning parameters 126 (e.g., learning track 410, learning goals 412, performance 4141, etc.), user device parameters 128, user grade level (e.g., as indicated by a user grade level adjuster 108 on the user device 104), and user language (e.g., as indicated by a user language adjuster 107 on the user device 104), as described herein. Subsequently, the chunk importance classifying model 134 determines an importance level for each personalized content chunk of each user based on the user's personal learning parameters 126 (e.g., learning track 410, learning goals 412, performance 4141, etc.) as described herein. Then, the assessment module 138 generates an assessment for one or more of the content chunks as described herein. The content chunks and associated assessments are then stored in the content chunk database 112.

For example, the content chunk database 112 may include three content chunks generated for a specific user and/or user device: chunk 1 416, chunk 2 418, and chunk 3 422. The importance levels of these chunks may be classified as “0”, “2”, and “3”, respectively. In this non-limiting example aspect, since chunk 1 416 has a relative importance level of “0”, no assessment is generated for this chunk. However, since chunk 2 418 and chunk 3 422 have higher relative importance levels of “2” and “3”, respectively, a chunk 2 assessment 420 is generated for chunk 2 418 and a chunk 3 assessment 424 is generated for chunk 3 422. In this example, level “2” corresponds to the “medium” level of importance, and level “3” corresponds to the “high” level of importance. In this non-limiting example aspect, not all three chunks need to be downloaded to the user device 104 at the same time. Instead, only a subset of the chunks and their associated assessments are downloaded to the storage 110 of the user device 104: e.g., only chunk 1 416 which does not have an assessment and chunk 2 418 and its associated chunk 2 assessment 420 are downloaded to the storage 110 of the user device 104. After chunk 1 416, chunk 2 418, and chunk 2 assessment 420 are successfully consumed via the user application 105 on the user device 104, then chunk 3 422 and its associated chunk 3 assessment 424 are downloaded to the storage 110 of the user device 104 for consumption.

Accordingly, instead of downloading an entire lecture or course, only necessary chunks are downloaded for consumption. Therefore, if a user wants or needs to take a break, he/she can quickly finish a current content chunk and have a break. Unlike existing system in which control of consumption of learning materials is achieved by analyzing the act of reading or playing materials that are divided in a general way without personalization, control of learning materials consumption in the present aspects is executed through personalized content chunks and according to their respective relative importance level.

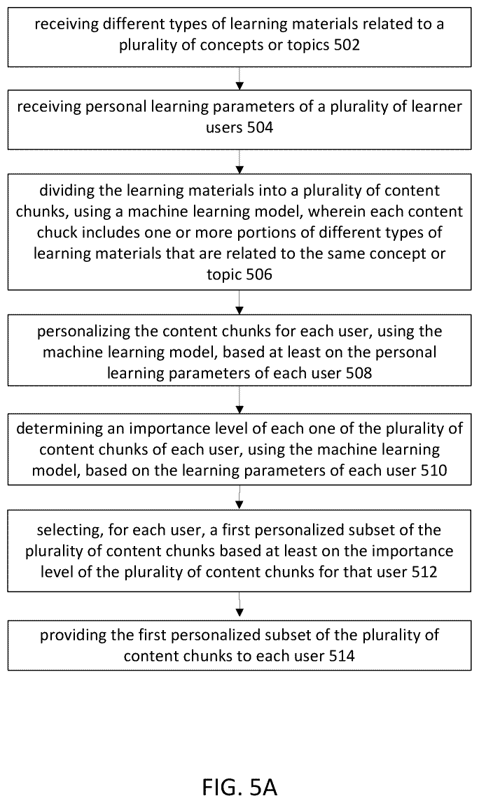

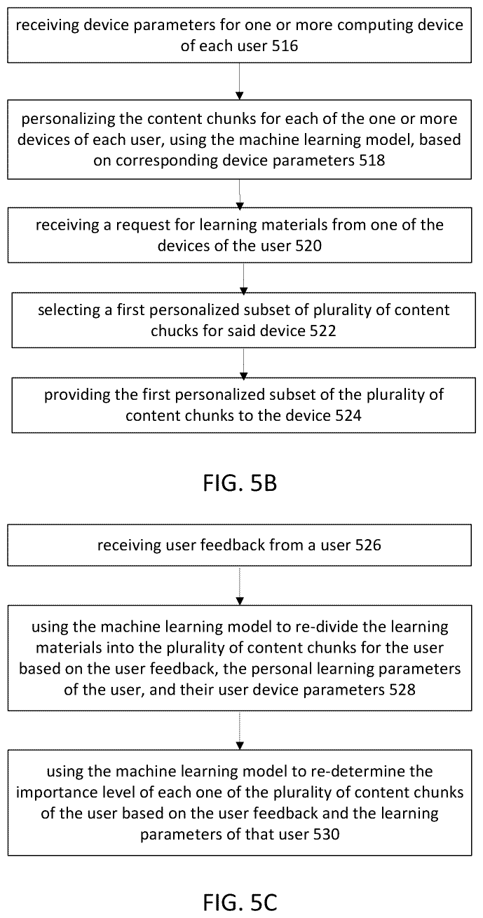

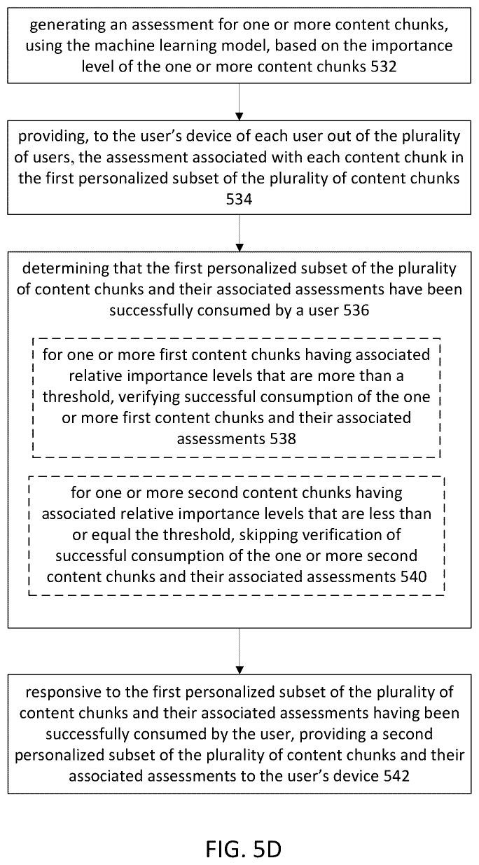

FIGS. 5A-5D include a flow diagram of a method 500 for generating personalized educational content for a plurality of users and managing content consumption by the plurality of users, according to aspects of the present disclosure. In various implementations, the method 500 is performed by a device with one or more processors and non-transitory memory. In some implementations, the method 500 is performed by processing logic, including hardware, firmware, software, or a combination thereof. In some implementations, the method 500 is performed by a processor executing code stored in a non-transitory computer-readable medium (e.g., a memory).

Referring to FIG. 5A, at block 502 the method 500 includes receiving different types of learning materials related to a plurality of concepts or topics. For example, the learning content management system 120 may receive different types of learning materials 124 related to a plurality of concepts or topics, as described herein.

At block 504 the method 500 includes receiving personal learning parameters of a plurality of learner users. For example, the learning content management system 120 may receive personal learning parameters 126 of the plurality of learner users 102, as described herein.

At block 506 the method 500 includes dividing the learning materials into a plurality of content chunks using a machine learning model, wherein each content chuck includes one or more portions of different types of learning materials that are related to the same concept or topic. For example, the content chunk generation module 122 may divide the learning materials 124 into a plurality of content chunks 114 using the chunk dividing model 130, wherein each content chuck 114 includes one or more portions of different types of learning materials 124 that are related to the same concept or topic, as described herein.

At block 508 the method 500 includes personalizing the content chunks for each user, using the machine learning model, based at least on the personal learning parameters of each user. For example, the content chunk generation module 122 may personalize the content chunks 116 for each learner user 102, using the chunk personalization model 132, based at least on the personal learning parameters 126 of each learner user 102, as described herein.

At block 510 the method 500 further includes determining an importance level of each one of the plurality of content chunks of each user, using the machine learning model, based on the learning parameters of each user. For example, the content chunk generation module 122 may determine an importance level of each one of the plurality of content chunks 116 of each learner user 102, using the chunk importance classifying model 134, based on the learning parameters 126 of each learner user 102, as described herein.

At block 512 the method 500 includes selecting, for each user, a first personalized subset of the plurality of content chunks based at least on the importance level of the plurality of content chunks for that user. For example, the chunk subset selection module 148 in the chunk consumption management module 146 may select, for each learner user 102, a first personalized subset of the plurality of content chunks 116 based at least on the importance level of the plurality of content chunks 116 for that learner user 102, as described herein.

At block 514 the method 500 includes providing the first personalized subset of the plurality of content chunks to each user. For example, the chunk consumption management module 146 may provide the first personalized subset of the plurality of content chunks 116 to each learner user 102, as described herein.

Referring to FIG. 5B, at block 516 the method 500 may further include receiving device parameters for one or more computing device of each user. For example, the learning content management system 120 may receive user device parameters 128 for one or more computing device 104 of each learner user 102, as described herein.

At block 518 the method 500 may further include personalizing the content chunks for each of the one or more devices of each user, using the machine learning model, based on corresponding device parameters. For example, the content chunk generation module 122 may personalize the content chunks 116 for each learner user 102, using the chunk personalization model 132, based on corresponding device parameters 128, as described herein.

At block 520 the method 500 may further include receiving a request for learning materials from one of the devices of the user. For example, the chunk consumption management module 146 may receive a request for learning materials 124 from the computing device 104A of the learner user 102A, as described herein.

At block 522 the method 500 may further include selecting a first personalized subset of plurality of content chucks for said device. For example, the chunk subset selection module 148 in the chunk consumption management module 146 may select a first personalized subset of the plurality of content chunks 116 for the computing device 104A of the learner user 102A, as described herein.

At block 525 the method 500 may further include providing the first personalized subset of the plurality of content chunks to the device. For example, the chunk consumption management module 146 may provide the first personalized subset of the plurality of content chunks 116 to the computing device 104A of the learner user 102A, as described herein.

In some implementations, dividing the learning materials 124 into a plurality of content chunks 114, personalizing the content chunks 116, and determining the importance level of the content chunks 116 is performed by two or more different machine learning models, such as, for example, the chunk dividing model 130, the chunk personalization model 142, and the chunk importance classifying model 134, respectively.

Referring to FIG. 5C, at block 526 the method 500 may further include receiving user feedback from a user. For example, the learning content management system 120 may receive user feedback 77 from the computing device 104A of the learner user 102A. For example, the user feedback 77 may indicate that the learner user 102A wishes to speed up or slow down their consumption of the learning materials 124.

At block 528 the method 500 may further include using the machine learning model to re-divide the learning materials into the plurality of content chunks for the user based on the user feedback, the personal learning parameters of the user, and their user device parameters. For example, the content chunk generation module 122 may use the chunk dividing model 130 to re-divide the learning materials 124 into the plurality of content chunks 114 for the learner user 102A based on the user feedback 77, the personal learning parameters 126 of the learner user 102A, and the user device parameters 128 of the computing device 104A of the learner user 102A.

At block 530 the method 500 may further include using the machine learning model to re-determine the importance level of each one of the plurality of content chunks of the user based on the user feedback and the learning parameters of that user. For example, the content chunk generation module 122 may use the chunk importance classifying model 134 to re-determine the importance level of each one of the plurality of content chunks 114 for the learner user 102A based on the user feedback 77 and the personal learning parameters 126 of the learner user 102A.

Referring to FIG. 5D, at block 532 the method 500 may further include generating an assessment for one or more content chunks, using the machine learning model, based on the importance level of the one or more content chunks, wherein the assessment includes one or more questions that tests a user's knowledge and/or understanding of an associated content chunk. For example, the content chunk generation module 122 may generate a chunk assessment 118 for one or more content chunks 116, using the assessment model 138, based on the importance level of the content chunks 116, wherein the chunk assessment 118 includes one or more questions that tests a user's knowledge and/or understanding of an associated content chunk 116, as described herein.

At block 534 the method 500 may include providing, to the user's device of each user out of the plurality of users, the assessment associated with each content chunk in the first personalized subset of the plurality of content chunks. For example, the chunk consumption management module 146 may provide, to the computing device 104A of the learner user 102A, the chunk assessment 118 associated with each content chunk in the first personalized subset of the plurality of content chunks 116, as described herein.

At block 536 the method 500 may further include determining that the first personalized subset of the plurality of content chunks and their associated assessments have been successfully consumed by a user. For example, the chunk consumption verification module 150 may determine that the first personalized subset of the plurality of content chunks 116 and their associated chunk assessments 118 have been successfully consumed by the learner user 102A, as described herein.

For example, at block 538 the method 500 may further include, for one or more first content chunks having associated relative importance levels that are more than a threshold, verifying successful consumption of the one or more first content chunks and their associated assessments. For example, for one or more first content chunks 116 having associated relative importance levels that are more than a threshold, the chunk consumption verification module 150 may verify successful consumption of the one or more first content chunks 116 and their associated chunk assessments 118, as described herein. Further, for example, at block 540 the method 500 may include, for one or more second content chunks having associated relative importance levels that are less than or equal the threshold, skipping verification of successful consumption of the one or more second content chunks and their associated assessments. For example, for one or more second content chunks 116 having associated relative importance levels that are less than or equal the threshold, the chunk consumption verification module 150 may skip verification of successful consumption of the one or more second content chunks 116 and their associated chunk assessments 118, as described herein.

At block 542 the method 500 may further include, responsive to the first personalized subset of the plurality of content chunks and their associated assessments having been successfully consumed by the user, providing a second personalized subset of the plurality of content chunks and their associated assessments to the user's device. For example, responsive to the first personalized subset of the plurality of content chunks 116 and their associated chunk assessments 118 having been successfully consumed by the learner user 102A, the chunk consumption management module 146 may provide a second personalized subset of the plurality of content chunks 116 and their associated chunk assessments 118 to the computing device 104A of the learner user 102A, as described herein.

In some implementations, the different types of materials 124 may include: text, audio, and/or video materials.

In some implementations, using the machine learning model at block 506 to divide the learning materials into the plurality of content chunks further includes: using the machine learning model to identify a plurality of similar concepts and/or topics within each type of the learning materials, and, when dividing the learning materials into the plurality of content chunks, include in each content chunk each type of material related to a similar concept and/or topic. For example, the content chunk generation module 122 may use the chunk dividing model 130 to identify a plurality of similar concepts and/or topics within each type of the learning materials 124, and, when dividing the learning materials 124 into the plurality of content chunks 114, include in each content chunk 114 each type of material related to a similar concept and/or topic, as described herein.

In some implementations, the personal learning parameters 126 of a user may include learning track, learning goals, and/or learning performance associated with the user.

In some implementations, the device parameters 128 of a user's device (102) may include at least a screen size of the user's device, and wherein each content chunk 116 is configured to fit within one page on a screen of the user's device (102).

In some implementations, personalizing the content chunks 116 for each user using the chunk personalization model 142 may be based on a grade level of each user.

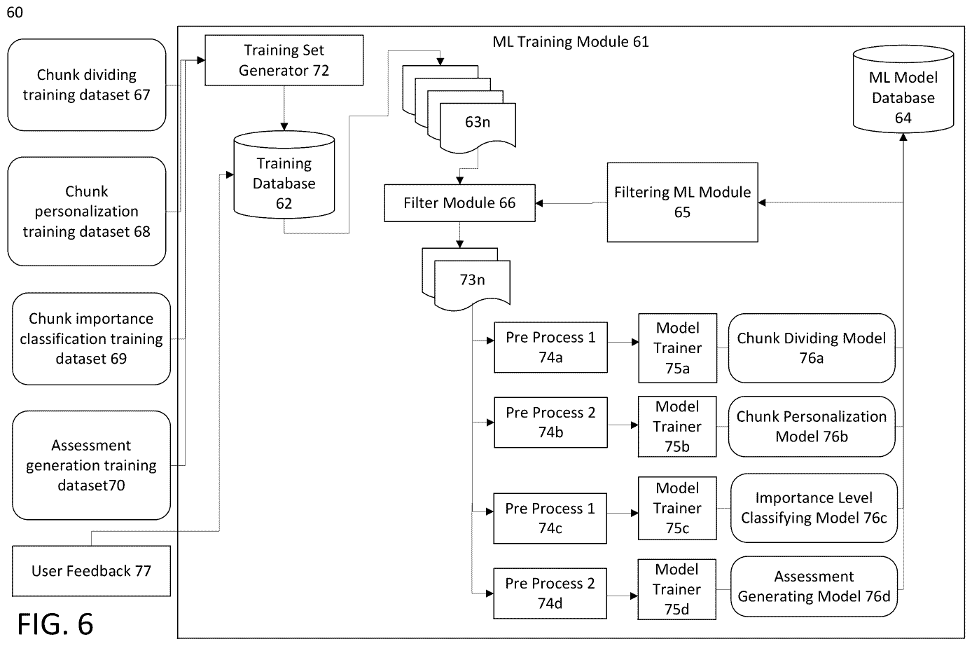

FIG. 6 is a block diagram illustrating an example of a system 60 for preparing (which may include training, retraining, distillation, fine-tuning, etc.) one or more machine learning models for dividing learning materials into a plurality of content chunks, one or more machine learning models for personalizing the content chunks for each user based on personal learning parameters of that user and user device parameters, one or more machine learning models for determining an importance level of each one of the plurality of content chunks of each user based on the learning parameters of that user, and one or more machine learning models for generating an assessment for one or more content chunks based on the importance level of the one or more content chunks, according to aspects of the present disclosure.

As shown in system 60, an ML training module 61 is configured to build and prepare (which may include training, retraining, distillation, fine-tuning, etc.) specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled trained data sets, the specialized machine learning models may perform particular tasks such as dividing learning materials into a plurality of content chunks, personalizing the content chunks for each user based on learning parameters of that user and their user device parameters, determining an importance level of each one of the plurality of content chunks of each user based on the learning parameters of that user, and generating an assessment for one or more content chunks based on the importance level of the one or more content chunks, as described herein.

Supervised learning is effective for tasks such as classification (assigning inputs to predefined categories) and regression (predicting continuous values) since it relies on the availability of labeled data for both training and evaluation phases. In supervised learning, the ML training module 61 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML training module 61 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the ML training module 61 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, the ML training module 61 refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the ML training module 61 includes at least a training database 62 configured to store the raw training data 63n and corresponding labels and user feedback 77 (see description of FIG. 5C above), a ML model database 64 configured to store the trained models (e.g., chunk dividing model 76a, chunk personalization model 76b, importance level classifying model 76c, and assessment generating model 76d). In some aspects, the ML training module 61 may include a filtering machine learning module 65 and a filter module 66 configured to filter data from the training database 62 for training by removing poorly generated training data.

Training data from a chunk dividing training dataset 67, a chunk personalization training dataset 68, a chunk importance classification training dataset 69, and an assessment generation training dataset 70 is received into the ML training module 61 via the training set generator 72. In some aspects, the chunk dividing training dataset 67 includes at least: a plurality of documents comprising learning materials associated with various educational courses, a plurality of appropriate content chunks generated by dividing the documents into a plurality of conceptually-related portions, and a plurality of inappropriate chunks generated by dividing the documents into conceptually-unrelated portions. In some aspects, the chunk personalization training dataset 68 includes at least: a plurality of personal learning parameters representing a plurality of users having different learning tracks/goals/performance, a plurality of device parameters representing different types of devices (e.g., different screen sizes), several different format templates (e.g., templates 310 and 320), and a plurality of content chunks. In some aspects, the chunk importance classification training dataset 69 includes at least: a plurality of personalized content chunks for each of a plurality of users, a plurality of personal learning parameters representing the plurality of users having different learning tracks/goals/performance, a plurality of appropriate relative importance levels of the content chunks, and a plurality of inappropriate relative importance levels of the content chunks. In some aspects, the assessment generation training dataset 70 includes at least: a plurality of personalized content chunks for each of a plurality of users, a plurality of relative importance levels of each content chunk, a plurality of appropriate assessments for the content chunks, and a plurality of inappropriate assessments for the content chunk.

An optional filter module 66 is configured to filter out bad training images and/or data in order to clean up the training data in the training dataset 63n. In some examples, the filter module 66 may be a neural network. In some examples, the filter module 66 is a mathematical model. In some examples, the cleaned training dataset 73n then undergoes optional preprocessing steps depending on which neural network or model is being trained.

The optional preprocess 1 74a, preprocess 2 74b, preprocess 3 74c, and preprocess 4 74d are automated processes that modify the raw data received from 63n (or cleaned training dataset 73n) and prepare the raw data as input to the respective model trainers 75a, 75b, 75c, 75d. These may be described in the machine learning training module 61 as snippets of code that prepares the datasets. In some examples, the preprocessing module (e.g., preprocess 1 74a, preprocess 2 74b, preprocess 3 74c, preprocess 4 74d) for a particular trainer may be an automated script or code that will be setup the first time any model is trained.

The model trainers 75a, 75b, 75c, 75d are the scripts or code that train the model. The model trainers 75a, 75b, 75c, 75d may be a script or code that holds the instructions on how a model should be trained (e.g., optimization method, model architecture, dataset division, etc.) and also runs the training. The model trainers 75a, 75b, 75c, 75d each take as input the raw or filtered processed training data and train the chunk dividing model 76a, the chunk personalization model 76b, the importance level classifying model 76s, and the assessment generating model 76d, to achieve their specific objectives, respectively.

In summary, the raw dataset 63n or cleaned dataset 73n may optionally go through different preprocessing steps 74a, 74b, 74c, 74d and then a corresponding one of the model trainers 75a, 75b, 75c, 75d to generate a trained chunk dividing model 76a, a trained chunk personalization model 76b, a trained importance level classifying model 76c, and a trained assessment generating model 76d. In some examples, each of these models may be a neural network.

As a non-limiting example, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 63n used for preparing a model (which may include training, retraining, distillation, fine-tuning, etc.) may include noise and bad training data from the training database 62. Accordingly, to create a clean and filtered training dataset, the filter module 66 is configured to filter out unwanted data points from the raw training dataset 63n by developing smaller, less accurate systems based on patterns and metadata information.

During the preparing process (which may include training, retraining, distillation, fine-tuning, etc.), the model trainers 75a, 75b, 75c, 75d (e.g., neural networks) are presented with input data and labels of actual values, and the optimization objective, which aims to minimize the difference between the actual value and the predicted value, is calculated. The optimization algorithm updates the parameters of the model trainers 75a, 75b, 75c, 75d to reduce the value of the objective. This process is repeated for several iterations until the parameters do not change anymore. This process is repeated for various combinations of hyperparameters, and the model with the smallest label prediction error is selected as the final model.

When a new model (e.g., a trained chunk dividing model 76a, a trained chunk personalization model 76b, a trained importance level classifying model 76c, and a trained assessment generating model 76d) is created, and a new process for filtering and automated labeling is established, it is added to the ML model database 64 in the ML training module 61. This enables the new model to be part of the closed-loop model update process. Optionally, at regular intervals, data which is continuously collected can be filtered, labeled, and used to update old models by an optional filtering machine learning module 65. In some examples, the filtering machine learning module 65 is a neural network. In some examples, the filtering machine learning module 65 is a mathematical model. This approach may capture changes in the data over time.

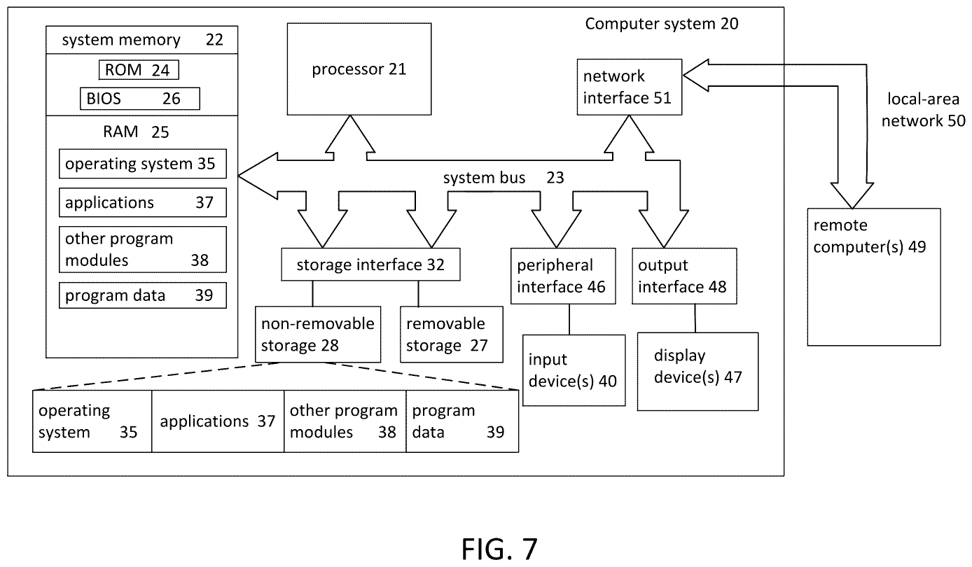

FIG. 7 is a block diagram illustrating a computer system 20 on which aspects of systems and methods for generating personalized educational content for a plurality of users and managing content consumption by the plurality of users may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the CPU 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any commands/steps/functions discussed herein with reference to FIGS. 1-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for providing personalized learning content, the method comprising:
receiving different types of learning materials related to a plurality of concepts or topics;
receiving personal learning parameters of a plurality of learner users;
dividing the learning materials into a plurality of content chunks using a machine learning model, wherein each content chuck includes one or more portions of different types of learning materials that are related to the same concept or topic;
personalizing the content chunks for each user, using the machine learning model, based at least on the personal learning parameters of each user;
determining an importance level of each one of the plurality of content chunks of each user, using the machine learning model, based on the learning parameters of each user;
selecting, for each user, a first personalized subset of the plurality of content chunks based at least on the importance level of the plurality of content chunks for that user; and
providing the first personalized subset of the plurality of content chunks to each user.

2. The method of claim 1, further comprising:
receiving device parameters for one or more computing device of each user;
personalizing the content chunks for each of the one or more devices of each user, using the machine learning model, based on corresponding device parameters;
receiving a request for learning materials from one of the devices of the user;
selecting a first personalized subset of plurality of content chucks for said device; and
providing the first personalized subset of the plurality of content chunks to the device.

3. The method of claim 1, wherein dividing the learning materials into a plurality of content chunks, personalizing the content chunks, and determining the importance level of the content chunks is performed by two or more different machine learning models.

4. The method of claim 1, further comprising:
receiving user feedback from a user;
using the machine learning model to re-divide the learning materials into the plurality of content chunks for the user based on the user feedback, the personal learning parameters of the user, and their user device parameters; and
using the machine learning model to re-determine the importance level of each one of the plurality of content chunks of the user based on the user feedback and the learning parameters of that user.

5. The method of claim 1, further comprising:
generating an assessment for one or more content chunks, using the machine learning model, based on the importance level of the one or more content chunks,
wherein the assessment includes one or more questions that tests a user's knowledge and/or understanding of an associated content chunk.

6. The method of claim 5, further comprising providing, to the user's device of each user out of the plurality of users, the assessment associated with each content chunk in the first personalized subset of the plurality of content chunks.

7. The method of claim 6, further comprising:
determining that the first personalized subset of the plurality of content chunks and their associated assessments have been successfully consumed by a user; and
responsive to the first personalized subset of the plurality of content chunks and their associated assessments having been successfully consumed by the user, providing a second personalized subset of the plurality of content chunks and their associated assessments to the user's device.

8. The method of claim 7, wherein determining that the first personalized subset of the plurality of content chunks and their associated assessments have been successfully consumed by the user comprises:
for one or more first content chunks having associated relative importance levels that are more than a threshold, verifying successful consumption of the one or more first content chunks and their associated assessments; and
for one or more second content chunks having associated relative importance levels that are less than or equal the threshold, skipping verification of successful consumption of the one or more second content chunks and their associated assessments.

9. The method of claim 1, wherein the different types of materials including: text, audio, and/or video materials.

10. The method of claim 1, wherein using the machine learning model to divide the learning materials into the plurality of content chunks further includes:
using the machine learning model to identify a plurality of similar concepts and/or topics within each type of the learning materials, and, when dividing the learning materials into the plurality of content chunks, include in each content chunk each type of material related to a similar concept and/or topic.

11. The method of claim 1, wherein the personal learning parameters of a user include learning track, learning goals, and/or learning performance associated with the user.

12. The method of claim 1, wherein the device parameters of a user's device comprise at least a screen size of the user's device, and wherein each content chunk is configured to fit within one page on a screen of the user's device.

13. The method of claim 1, further comprising:
personalizing the content chunks for each user, using the machine learning model, based on a grade level of each user.

14. A system for providing personalized learning content, comprising:
at least one memory; and
at least one hardware processor coupled with the at least one memory and configured, individually or in combination, to:
receive different types of learning materials related to a plurality of concepts or topics;
receive personal learning parameters of a plurality of learner users;
divide the learning materials into a plurality of content chunks using a machine learning model, wherein each content chuck includes one or more portions of different types of learning materials that are related to the same concept or topic;
personalize the content chunks for each user, using the machine learning model, based at least on the personal learning parameters of each user;
determine an importance level of each one of the plurality of content chunks of each user, using the machine learning model, based on the learning parameters of each user;
select, for each user, a first personalized subset of the plurality of content chunks based at least on the importance level of the plurality of content chunks for that user; and
provide the first personalized subset of the plurality of content chunks to each user.

15. The system of claim 14, wherein the at least one hardware processor is further configured to:
receive device parameters for one or more computing device of each user;
personalize the content chunks for each of the one or more devices of each user, using the machine learning model, based on corresponding device parameters;
receiving a request for learning materials from one of the devices of the user;
select a first personalized subset of plurality of content chucks for said device; and
provide the first personalized subset of the plurality of content chunks to the device.

16. The system of claim 13, wherein dividing the learning materials into a plurality of content chunks, personalizing the content chunks, and determining the importance level of the content chunks is performed by two or more different machine learning models.

17. The system of claim 13, wherein the at least one hardware processor is further configured to:
receive user feedback from a user;
use the machine learning model to re-divide the learning materials into the plurality of content chunks for the user based on the user feedback, the personal learning parameters of the user, and their user device parameters; and
use the machine learning model to re-determine the importance level of each one of the plurality of content chunks of the user based on the user feedback and the learning parameters of that user.

18. The system of claim 13, wherein the at least one hardware processor is further configured to:
generate an assessment for one or more content chunks, using the machine learning model, based on the importance level of the one or more content chunks,
wherein the assessment includes one or more questions that tests a user's knowledge and/or understanding of an associated content chunk.

19. The system of claim 18, wherein the at least one hardware processor is further configured to provide, to the user's device of each user out of the plurality of users, the assessment associated with each content chunk in the first personalized subset of the plurality of content chunks.

20. A non-transitory computer readable medium storing thereon computer executable instructions for providing personalized learning content, including instructions for:
receiving different types of learning materials related to a plurality of concepts or topics;
receiving personal learning parameters of a plurality of learner users;
dividing the learning materials into a plurality of content chunks using a machine learning model, wherein each content chuck includes one or more portions of different types of learning materials that are related to the same concept or topic;
personalizing the content chunks for each user, using the machine learning model, based at least on the personal learning parameters of each user;
determining an importance level of each one of the plurality of content chunks of each user, using the machine learning model, based on the learning parameters of each user;
selecting, for each user, a first personalized subset of the plurality of content chunks based at least on the importance level of the plurality of content chunks for that user; and
providing the first personalized subset of the plurality of content chunks to each user.
